(19) United States
(12) Patent Application Publication
(10) Pub. No.: US 2005/0204541 A1
(43) Pub. Date: Sep. 22, 2005

(54) Method for manufacturing clutch housing

(75) Inventor: Tomoyuki Miyazaki, Fukuroi-shi (JP)

Correspondence Address: MILES & STOCKBRIDGE PC, 1751 PINNACLE DRIVE, SUITE 500, MCLEAN, VA, 22102-3833, US

(73) Assignee: NSK-Warner K.K.

(21) Appl. No.: 10/997,979

(22) Filed: Nov. 29, 2004

(30) Foreign Application Priority Data
Nov. 28, 2003 (JP) 2003-398423

(51) Int. Cl. B23P 13/04

(52) U.S. Cl. 29/557

(57) ABSTRACT

In a method for manufacturing a clutch housing integrally formed so as to have a shaft portion and an outer drum portion surrounding the shaft portion integrated with the shaft portion, the method is constituted by a first step of forming the shaft portion by plastically working a blank, a second step of applying a machine work to the shaft portion, and a third step of forming the outer drum portion surrounding the shaft portion in accordance with a plastic working.

### BACKGROUND OF THE INVENTION

1. Field of the Invention

The present invention relates to a method for manufacturing a clutch housing employed in an automatic transmission of a vehicle or the like.

2. Related Background Art

In general, in an automatic transmission of a motor vehicle or the like, that is, in an automatic transmission (AT), a drum type clutch housing is employed. The clutch housing mentioned above is manufactured at a predetermined accuracy and size in accordance with a hot forging or the like.

In general, the clutch housing is constituted by a center shaft portion and an outer drum portion connected thereto. The shaft portion and the outer drum portion are firmly connected in accordance with a welding process, a caulking process or the like.

Further, there has been known a manufacturing method structured such that a predetermined accuracy can be secured by previously forging the clutch housing in a product shape in accordance with a hot forging and thereafter executing a cold forging (refer, for example, to Japanese Patent Application Laid-Open No. 3-189044). In this example, the shaft portion and the outer drum portion are integrally formed.

The clutch housing described above has the following problem.

The conventional clutch housing is manufactured by working the outer drum portion provided with a spline in an outer periphery and the shaft portion by different members, and thereafter integrally fastening them in accordance with a welding process, a caulking process and the like. Accordingly, it is easy to form an oil hole and a notch in the shaft portion, and on the contrary, there is a problem that a strength and an accuracy of the fastened portion are deteriorated.

In order to solve the problem in the case of manufacturing by connecting the different members, it is necessary to integrally form in accordance with the forging, for example, as described in Japanese Patent Application Laid-Open No. 3-189044. However, in accordance with the method disclosed in patent document 1, since the hot forging process is used, both of an apparatus and a step tend to become comparatively large scale. Accordingly, there has been yet a lot of problems in view of a mass production and a cost.

Further, a cylinder portion of the housing forms an obstacle, so that there is generated the other problem that it is impossible to accurately form the oil hole at a predetermined position by a drill. Further, there is generated the same problem in working the notch such as a groove or the like provided in the shaft portion.

### SUMMARY OF THE INVENTION

Accordingly, an object of the present invention is to provide a method for manufacturing a clutch housing which can mass-produce the clutch housing at a low cost, in which it is possible to improve a strength and an accuracy by using an integrally formed raw material as well as it is possible to easily work an oil hole and a notch without being affected by a shape of an outer drum portion.

In order to achieve the object mentioned above, in accordance with the present invention, there is provided a method for manufacturing a clutch housing integrally formed so as to have a shaft portion and an outer drum portion surrounding the shaft portion integrated with the shaft portion, comprising:

a first step of forming the shaft portion by plastically working a blank;

a second step of applying a machine work to the shaft portion; and

a third step of forming the outer drum portion surrounding the shaft portion in accordance with a plastic working.

In accordance with the method for manufacturing the clutch housing on the basis of the present invention, the following effects can be obtained.

It is possible to improve a strength and an accuracy by using an integrally formed raw material as well as it is possible to easily work an oil hole and a notch without being affected by a shape of the outer drum portion. Further, since a simple working method such as a press molding or the like is used without using a hot forging and without requiring a particular method or step such as a flow forming or the like, it is possible to mass-produce the clutch housing at a low cost.

It is possible to improve the strength and the accuracy by using the integrally formed raw material, and it is possible to mass-produce the clutch housing at a low cost by forming by means of the simple press molding, without using the special method and step such as the flow forming or the like.

### BRIEF DESCRIPTION OF THE DRAWINGS

FIG. 1 is a cross sectional view in an axial direction of a work used in an embodiment in accordance with the present invention;

FIG. 2 is a view showing a step of forming a shaft portion;

FIG. 3 is a view showing a state in which a top plate portion of the work shown in FIG. 2 is punched out;

FIG. 4 is a view showing a step of applying a machine work to the shaft portion;

FIG. 5 is a view showing a step of applying a drawing work to the work;

FIG. 6 is a view showing a step of forming an outer drum portion by applying a drawing work to the work;

FIG. 7 is a cross sectional view in an axial direction of a clutch housing formed as an approximately completed product by working a spline on the outer side drum; and

FIG. 8 is a partial cross sectional view in an axial direction showing a portion around the shaft portion in FIG. 4 in an enlarged manner.

### DETAILED DESCRIPTION OF THE PREFERRED EMBODIMENTS

A description will be in detail given below of each of embodiments in accordance with the present invention with reference to the accompanying drawings. In this case, the same portions are denoted by the reference numerals in the drawings. Further, it goes without saying that each of the embodiments described below is explained as an exemplification of the present invention, and does not limit the present invention.

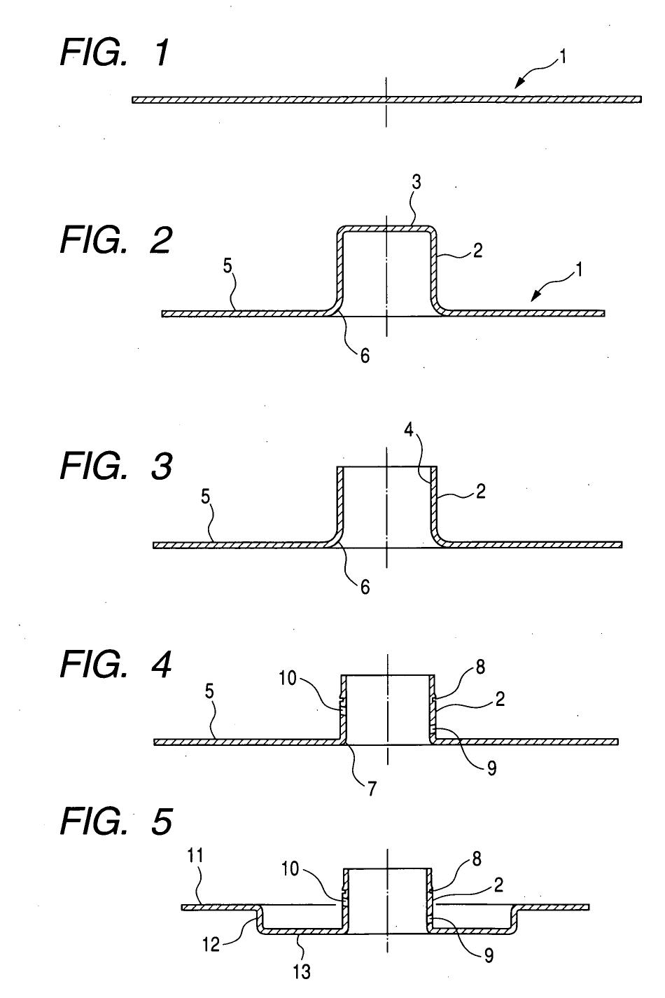

FIGS. 1 to 7 are cross sectional views in an axial direction showing an embodiment of a method of manufacturing a clutch drum, that is, a clutch housing, and show steps of forming a completed product from a raw material blank, that is, a work in accordance with a plastic working, that is, a press working. First, as shown in FIG. 1, the work (the raw material) 1 corresponding to an approximately circular plate-like steel plate is prepared at a predetermined magnitude so as to obtain a shape and a volumetric capacity which are necessary for a clutch housing to be manufactured.

Next, the work 1 is formed in a shape as shown in FIG. 2 in accordance with the plastic working by means of a press molding. In FIG. 2, the work 1 is formed in such a manner as to be constituted by an approximately flat disc portion 5, an approximately cylindrical shaft portion 2, and a top plate portion 3 covering the shaft portion 2. An annular curved surface portion 6 having a predetermined curvature is formed between the disc portion 5 and the shaft portion 2.

Next, in FIG. 3, when punching out the top plate portion 3 by the press molding, a through hole 4 is formed in an inner portion of the shaft portion 2. Thereafter, as shown in FIG. 4, a machine work is applied to the work 1.

In FIG. 4, an annular circumferential groove 8 is formed in an outer periphery near the shaft portion 2, in accordance with a turning work corresponding to the machine work. A stopper ring or an O-ring is fitted to the circumferential groove 8. Further, oil holes 9 and 10 passing through a cylinder portion of the shaft portion 2 are formed by a drill or the like. A plurality of oil holes 9 and 10 are provided in a peripheral direction, however, the number thereof is optional. In this case, it is preferable that the oil holes are provided uniformly in the peripheral direction. At this time, since nothing exists around the shaft portion 2, it is easy to apply a blade of the drill used for forming the oil hole, and it is possible to pierce at an accurate position.

FIG. 8 is a partial cross sectional view in an axial direction showing a portion around the shaft portion in FIG. 4 in an enlarged manner. FIG. 8 shows details of the circumferential groove 8 and the oil holes 9 and 10. In the drawing, the oil holes 9 and 10 are formed so as to have a predetermined angle with respect to an axial core of the shaft portion 2, however, it is possible to pierce perpendicularly to the shaft portion 2. Further, in the machine work step shown in FIG. 4, a corner portion 7 in which a curvature of the curved surface portion 6 is made small is formed by applying a drawing work to the work 1.

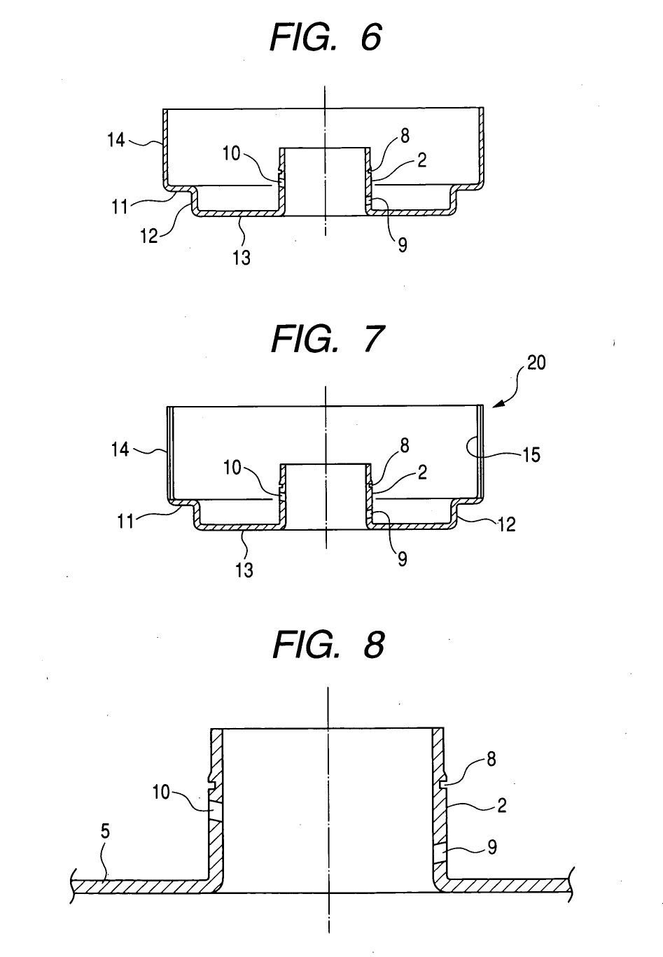

FIGS. 5 and 6 show a step of applying the drawing work to the work 1, molding the housing and forming the outer drum portion. First, in FIG. 5, an inner-diameter disc portion 13 and an outer-diameter disc portion 11 are formed by applying the drawing work to the disc portion 5. The inner-diameter disc portion 13 and the outer-diameter disc portion 11 are connected by a first cylinder portion 12.

Next, in FIG. 6, an approximately cylindrical outer drum portion 14 is formed by further applying the drawing work to the work 1 and deforming the outer-diameter disc portion 11. As is apparent from FIGS. 5 and 6, a height of the cylinder portion 12 is about one half of the shaft portion 2, however, the outer drum portion 14 extends in an axial direction so as to completely cover the shaft portion 2.

Finally, in FIG. 7, a spline 15 is worked on an inner periphery of the outer drum portion 14. In other words, an approximately completed clutch housing 20 is obtained by molding a tooth form on the inner periphery. In FIG. 7, the spline 15 is provided on the inner periphery of the outer drum portion 14, however, the spline may be provided on an outer periphery of the outer drum portion 14.

After the step in FIG. 7, a step of turning an entire of the product so as to finish is executed. In this case, a friction engaging apparatus (not shown) serving as a clutch is arranged in a space surrounded by the outer drum portion 14, and a piston (not shown) pressing the frictional engaging apparatus is arranged so as to be movable on the basis of a pressure of an oil within a hydraulic chamber (not shown) defined between the piston and the disc portion 13.

The clutch housing formed in accordance with the manufacturing method on the basis of the present invention can be used in an automatic transmission, however, a multi-disc type frictional engaging apparatus installed in an inner portion may employ either of a wet type and a dry type.

1. A method for manufacturing a clutch housing integrally formed so as to have a shaft portion and an outer drum portion surrounding the shaft portion integrated with the shaft portion, comprising:
a first step of forming the shaft portion by plastically working a blank;
a second step of applying a machine work to said shaft portion; and
a third step of forming the outer drum portion surrounding said shaft portion in accordance with a plastic working.

2. A method for manufacturing a clutch housing as claimed in claim 1, further comprising a step of forming a spline in said outer drum portion and forming the clutch housing to an approximately completed product.

3. A method for manufacturing a clutch housing as claimed in claim 1, wherein said machine work in said second step includes at least any one of forming an oil hole in said shaft portion and forming a groove in an outer periphery.

4. A method for manufacturing a clutch housing as claimed in claim 2, wherein said machine work in said second step includes at least any one of forming an oil hole in said shaft portion and forming a groove in an outer periphery.

5. A method for manufacturing a clutch housing as claimed in claim 1, wherein a finishing step of finishing on the basis of a turning operation or the like is executed after said third step.

6. A method for manufacturing a clutch housing as claimed in claim 2, wherein a finishing step of finishing on the basis of a turning operation or the like is executed after said third step.

7. A method for manufacturing a clutch housing as claimed in claim 3, wherein a finishing step of finishing on the basis of a turning operation or the like is executed after said third step.

8. A method for manufacturing a clutch housing as claimed in claim 4, wherein a finishing step of finishing on the basis of a turning operation or the like is executed after said third step.
